(19) United States
(12) Patent Application Publication
(10) Pub. No.: US 2018/0262073 A1
(43) Pub. Date: Sep. 13, 2018

(54) ELECTRICAL INSULATING MATERIAL

(71) Applicant: 3M INNOVATIVE PROPERTIES COMPANY, St. Paul, MN (US)

(72) Inventors: Shuji Takagi, Hachioji-city (JP); Sybil Z. Wong, Austin, TX (US); Robert L. Lambert, Austin, TX (US); Pradip K. Bandyopadhyay, Austin, TX (US); David V. Mahoney, Austin, TX (US)

(21) Appl. No.: 15/916,921

(22) Filed: Mar. 9, 2018

Related U.S. Application Data
(60) Provisional application No. 62/469,713, filed on Mar. 10, 2017.

(51) Int. Cl. H02K 3/30; H02K 3/34; B32B 7/12; B32B 3/04; B32B 27/28; B32B 27/34; B32B 27/36; B32B 27/08

(52) U.S. Cl. CPC H02K 3/30; B32B 2457/00; B32B 7/12; B32B 3/04; B32B 27/286; B32B 27/34; B32B 27/281; B32B 27/36; B32B 27/08; B32B 2250/02; B32B 2255/26; B32B 2307/206; B32B 2377/00; B32B 2379/08; B32B 2367/00; H02K 3/345

(57) ABSTRACT

An electrical insulating material is described herein. The electrical insulating material comprises an insulating core layer and at least one cured epoxy layer coated on a first major surface of the insulating core layer. In some aspects, the exemplary electrical insulating material can further include a second cured epoxy layer coated on a second major surface of the insulating core layer.

### FIELD OF THE INVENTION

The present invention relates to an electrical insulating material for use in electrical devices. In particular, the insulating material is a flexible material that comprises at least one epoxy layer. In one aspect, the exemplary insulating material can be used for slot liners in electrical devices or motors with improved the thermal performance, mechanical performance, chemical resistance and/or dielectric properties.

### BACKGROUND OF THE INVENTION

Rotating electric machines or electric motors are used for a wide variety of applications, such as automotive applications, aerospace applications, industrial applications, and/or the like. Rotating electric machines or motors include a stator and a rotor that rotates relative to the stator to convert electrical energy to mechanical energy. Rotating electric machines can also include electrical generators where the relative rotation between the rotor and the stator converts mechanical energy to electrical energy.

Electrical equipment or machines such as electric motors, generators, and transformers often require some form of dielectric insulation to separate a conductor at one voltage from a conductor at a different voltage and/or to provide mechanical protection to electrical components.

For example, electrical generators convert mechanical energy to electrical energy as a result of the relative rotation between the rotor and the stator. Stators typically include a stator core having a plurality of spaced apart teeth with slots in between said teeth. Wire coils are wound around teeth of the stator core in the slots. Dielectric insulation in the form of insulating slot liners may be provided within the stator slots to electrically isolate the wire coils from the stator core. Similarly, rotors can also use slot liners within rotor slots of the rotor to electrically isolate rotor coils from the rotor core.

Conventional slot liners can include filled materials such as mica based insulating materials, a single layer film such as a polyimide film or a laminate of a film with nonwoven material, for example laminate material having polyphenylene sulfide nonwoven material disposed on both sides of polyimide film. Slot liners need to meet some rigorous mechanical, chemical, thermal and dielectric properties. Conventional slot liner material have difficulty meeting all of the necessary requirements.

For example, rotary electrical machines used in high temperature environments require adequate heat resistance of slot liners. Mica based insulation materials have been used that combine mica flakes in a resin binder. These mica based materials can be brittle and break during insertion into the slots of either stators or rotors during fabrication. In addition, the thermal resistance of the mica based material is only as good as the thermal resistance of the resin binder. To address the brittleness of these mica based materials, a reinforcing resin layer can be added to the mica based material. However, the thermal expansion mismatch between the mica based material and the reinforcing layer can cause separation of the reinforcing layer and the mica-based material, resulting in reduced thermal performance of the electrical device.

A need exists for more durable slot liner materials for use in electrical devices and motors.

### SUMMARY OF THE INVENTION

An electrical insulating material is described herein. The electrical insulating material comprises an insulating core layer and at least one cured epoxy layer coated on a first major surface of the insulating core layer. In some aspects, the exemplary electrical insulating material can further include a second cured epoxy layer coated on a second major surface of the insulating core layer.

In some embodiments, the core layer comprises an insulating film. In other embodiments, the core layer comprises an insulating film layer and at least one nonwoven layer disposed on a first surface of the insulating film layer.

As used in the specification:

“directly bonded” refers to the joining of layers without use of an adhesive layer.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is a schematic diagram showing the layer structure of a first exemplary slot liner according to an embodiment of the present invention.

FIG. 2 is a schematic diagram showing the layer structure of a second exemplary slot liner according to an embodiment of the present invention.

FIG. 3 is a schematic diagram showing the layer structure of a third exemplary slot liner according to an embodiment of the present invention.

FIG. 4 is a schematic diagram showing the layer structure of a fourth exemplary slot liner according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following detailed description of the preferred embodiments, reference is made to the accompanying drawings, which form a part hereof, and in which is shown by way of illustration specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

In the exemplary insulating materials described herein inclusion of an epoxy coating or layer can improve at least one of the thermal performance, mechanical performance, chemical resistance and/or dielectric properties of an insulating slot liner material. The exemplary slot liner material comprises a core layer having a first major surface and a second major surface and a cured epoxy layer disposed on at least one of these major surfaces.

Epoxy-based coating layers on the surface of the core layer or in between film and/or non-woven components may help to enhance properties not provided by the individual film and/or non-woven components. For example, polyethylene-naphthalate (PEN) films are not as chemically resistant as PI films, and can degrade at high temperatures when exposed to certain chemicals. When an epoxy-based coating layer is disposed on the surface(s) of a PEN film layer, the epoxy coating can act as a barrier to penetration of said chemical to prevent or retard the degradation of the PEN film.

In another example, the comparative tracking index (CTI) rating of an electrical insulating material can be improved by use an epoxy coating layer as the external layer(s) of the material. Since the CTI rating is somewhat dependent on the exterior, exposed layer of the electrical insulating material, an epoxy-based overcoat may improve the CTI rating of an insulation material having a lower performing film and/or nonwoven layer(s) on its outside surfaces.

The invention described herein is a composite insulation film comprising a cured epoxy coating on a base polymer film (polyethylene terephthalate, polyaramid, etc.) for use as a slot liner to provide insulation for components of an electric motor. The exemplary electrical insulating material is a cost-effective composite material that exhibits suitable mechanical, thermal, abrasion resistant, and chemical resistant properties as compared to similar materials without the exemplary coating layer(s).

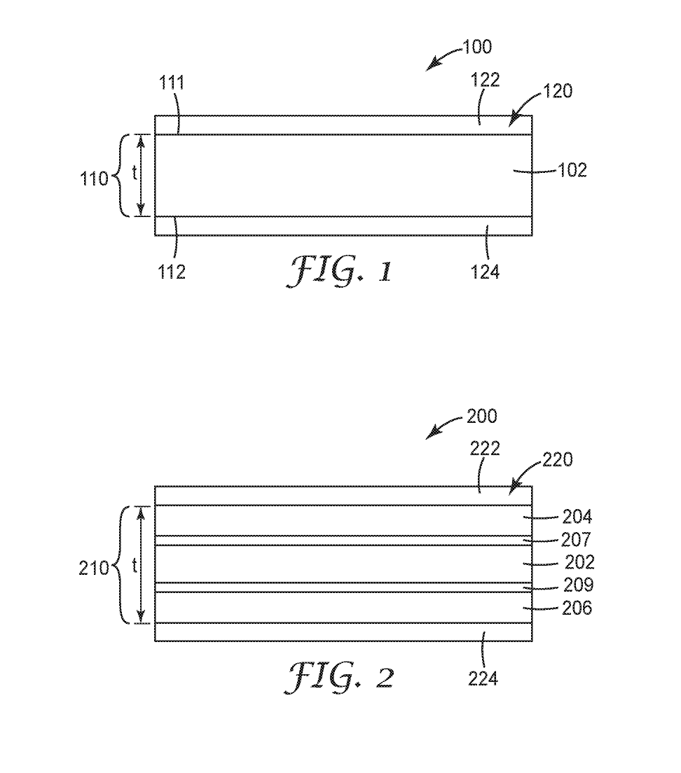

FIGS. 1-4 illustrate different embodiments of exemplary flexible electrical insulating materials for slot liners of the present disclosure. FIG. 1 shows a first exemplary slot liner 100 having a core layer 110. The core layer comprises an insulating layer 102 and has a first major surface 111 and a second major surface 112 opposite the first major surface on either side of the insulating layer. An epoxy layer 120 is disposed on each major surface, i.e. a first epoxy layer 122 is disposed on the first major surface and a second epoxy layer 124l is disposed on the second major surface. In an exemplary aspect, the epoxy layer thickness can b between about 0.5 mils and about 5 mils, preferably between about 1 mils and 2.5 mils. Exemplary epoxy layers can comprise an epoxy resin, a hardener/crosslinker, a catalyst/accelerator, and aluminum trihydrate (ATH).

The exemplary flexible electrical insulating materials can be provided in sheet form, roll form or a preformed three-dimensional shape configured to fit into a slot of a motor coil. The three-dimensional shape can be a channel having one of a U-shaped cross-section, an elliptical cross-section, a rectangular cross section and a dovetail cross-section. In some embodiments, the ends of the insulating material is folded back at one or both ends to form a cuff to reinforce the three-dimensional shape.

In one aspect, the epoxy resin in this composition can be based on bis-phenol-A epoxy or modified bis-phenol-A such as epoxy phenol novalacs or epoxy cresol novalacs, glycidyl amine based epoxy resins, cycloaliphatic epoxy resins or mixtures thereof. Exemplary hardeners can comprise aliphatic, aromatic and cycloaliphatic amines such as trimethyl hexamethylene diamine and polyether amines or anhydrides, such as hexahydrophthalic anyhride, dodecyl succinic anhydride and methyl tetrahydrophthalic anhydride. In some aspects, curing accelerators can include benzyl dimethyl amine, heterocyclic amines, tertiary amines and a boron trichloride amine complex. Optionally the epoxy layer may also include a polypropylene glycol based flexibilizer such as Araldite® DY 040 from Huntsman Advanced Materials Americas (The Woodlands, Tex.) or similar polyglycols and polyols.

In a preferred aspect, the epoxy layer comprises a cycloaliphatic epoxy resin and an anhydride hardener.

In one aspect, the epoxy layer can be comprised of thermally stable and chemically resistant polymers including epoxy resins and other thermoset resins. In another aspect the epoxy layer can optionally contain fillers such as flame retardants, calcium carbonate, mica, tougheners, and flexibilizers.

The cured epoxy layer of any of the previous embodiments can comprise a cycloaliphatic epoxy resin, a hardener, and aluminum trihydrate. In an exemplary aspect, the cured epoxy layer comprises of 15-50 wt. % cycloaliphatic epoxy resin, 10-50 wt. % anhydride hardener, and 10-70 wt. % aluminum trihydrate. Preferably, the cured epoxy layer may consist essentially of 20-46 wt. % cycloaliphatic epoxy resin, 14-40 wt. % anhydride hardener, and 14-60 wt. % aluminum trihydrate. The cured epoxy layer could further include 0-2 wt. % accelerator.

The core layer can be an insulating film, an insulating nonwoven material or a laminate comprising a plurality of layers of insulating film and/or nonwoven material. The core layer can be characterized by a core layer thickness, t. In an exemplary aspect, the core layer thickness can be between about 3 mils and about 10 mils, preferably between about 5 mils and 8 mils. Exemplary insulating films useable in the present invention can include polyimide film such as Kapton® polyimide (PI) films available from Dupont (Wilmington, Del.), polyester films, Polyethylene naphthalate (PEN) films, polyethylene terephthalate (PET) films, polyamide-imide films, polycarbonate (PC) films, and multi-layer PEN/polymethylmethacrylate (PMMA) films. Exemplary nonwoven materials can include nylon nonwoven materials, polyphenylene sulfide (PPS) nonwoven materials, nylon nonwoven materials, para-aramid and/or meta-aramid nonwoven materials, acrylic nonwoven materials, melamine nonwoven materials, glass nonwoven materials, polyolefin nonwoven materials, polyimide nonwoven materials and polyethylene terephthalate (PET) nonwoven materials.

Exemplary slot liners can have a total thickness between about 5 mils and about 12 mils, preferably between about 6.0 mils and 10 mils.

FIG. 2 is a schematic diagram showing the layer structure of a second exemplary flexible electrical insulating material 200 for a slot liner having a laminate core layer 210. In an exemplary embodiment, core layer 210 comprises a central film layer 202 and two nonwoven layers 204, 206 laminated to the central film layer with an adhesive layer 207, 209. An epoxy layer 220 is disposed on each major surface of the core layer, i.e. a first epoxy layer 222 is disposed on the first major surface and a second epoxy layer 224 is disposed on the second major surface of core layer 210.

Adhesive layers 207, 209 can be any suitable adhesive. For example, the adhesive may be water-based or solvent-based. The adhesive may have any suitable composition. The adhesive may include pressure sensitive adhesives, hotmelt adhesives, thermally curing adhesives, or other curable adhesives or resins. Examples of suitable compositions include acrylic, styrene, and polyester. Optionally, and preferably, a flame retardant may be added to the adhesive. The flame retardant may be any suitable material. Examples of suitable flame retardant materials include metal hydroxides and hydrates, e.g., magnesium hydroxide (Mg(OH)₂) and aluminum trihydrate, respectively. The flame retardant may comprise up to about 70 wt. % of the adhesive, preferably up to 60 wt. %. Adding too much flame retardant will decrease the adhesive properties of the adhesive. An optional surface treatment can be performed on the surface of either the film layer and/or the nonwoven layer to enhance the bond strength of the adhesive to these layers. The adhesive can be knife coated, roll coated or spray applied to the film layer, followed by the lamination of the nonwoven material onto the adhesive coated surface. Alternatively, the adhesive can be spray coated onto the surface of the nonwoven material layers which can then be laminated to either side of the film layer.

While the core layer of this embodiment has been described as having a central film layer and two outer nonwoven layers, one of ordinary skill in the art will recognize that the materials used in each layer can be either a film layer or a nonwoven layer and that the laminate core layer can comprise two or more separate layers as needed by a given application.

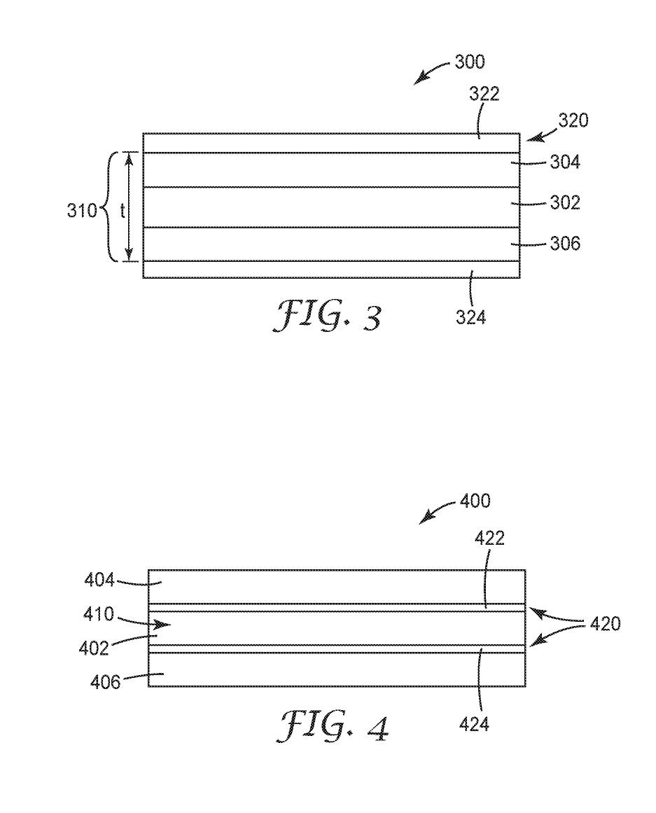

In an alternative embodiment of an exemplary flexible electrical insulating material 300 for a slot liner, no adhesive is applied to join the various layers or sub-layers of the core layer together as shown in FIG. 3. Instead, the nonwoven layer(s) 304, 306 and film layer(s) 302 are bonded by calendering with only heat and pressure to form core layer 310. Two epoxy layers 322, 324 can be applied to the outside surfaces of the core layer as described previously.

FIG. 4 shows the layer structure of a fourth exemplary flexible electrical insulating material 400 for a slot liner wherein the core layer 410 is bonded to two outer layers by epoxy layers 420. For example, a nonwoven outer layer 404, 406 can be bonded to a film core layer 402 by an epoxy layer 422, 424.

In an embodiment, a flexible electrical insulating material can comprise an insulating core layer and at least one cured epoxy layer coated on a first major surface of the insulating core layer, wherein the insulating core layer is a laminate comprising first layer of a nonwoven material attached to a first surface of an insulating film by a laminating adhesive.

In some aspects, a first layer of the at least one cured epoxy layer is coated on an exposed surface of the first layer of a nonwoven material, while in other aspects, a first layer of the at least one cured epoxy layer is coated on an exposed surface of the film.

In another embodiment, a flexible electrical insulating material can comprise an insulating core layer and at least one cured epoxy layer coated on a first major surface of the insulating core layer, wherein the insulating core layer is a laminate comprising first layer of a nonwoven material attached to a first surface of an insulating film by a laminating adhesive and a second layer of a nonwoven material is attached to a second surface of a polymer film.

In an alternative aspect, either of the two previous embodiments may have the at least one cured epoxy layer coated on both major surfaces of the core layer.

In yet another embodiment, a flexible electrical insulating material comprises insulating film layer, a first cured epoxy layer disposed on a major surface of the insulating film layer and a first nonwoven material layer disposed on an exposed surface of the first cured epoxy layer. Optionally, a second cured epoxy layer disposed on the second major surface of the insulating film. Alternatively, the insulating material above may further include a second nonwoven material layer disposed on an exposed surface of the second cured epoxy layer.

The cured epoxy layer of any of the previous embodiments can comprise a cycloaliphatic epoxy resin, a hardener, and aluminum trihydrate. In an exemplary aspect, the cured epoxy layer comprises of 15-50 wt. % cycloaliphatic epoxy resin, 10-50 wt. % anhydride hardener, and 10-70 wt. % aluminum trihydrate. Preferably, the cured epoxy layer may consist essentially of 20-46 wt. % cycloaliphatic epoxy resin, 14-40 wt. % anhydride hardener, and 14-60 wt. % aluminum trihydrate. The cured epoxy layer could further include 0-2 wt. % accelerator.

The insulating film of any of the previous embodiments, can comprise one of a polyimide film and a polyethylene-naphthalate film, and the nonwoven material can comprise one of a polyphenylene sulfide nonwoven material and a nylon nonwoven material.

The insulating material of any of the preceding embodiments has a comparative tracking index of at least about 350 V. In another aspect, the insulating material of any of the preceding embodiments has a comparative tracking index of at least about 575 V.

The insulating material of any of the preceding embodiments can be formed into a three-dimensional shape configured to fit into a slot of a motor coil, wherein the three-dimensional shape is a channel having one of a U-shaped cross-section, an elliptical cross-section, a rectangular cross section and a dovetail cross-section. In some aspects, the insulating material of the three dimensional shape are folded back at one or both ends to form a cuff to reinforce the three-dimensional shape.

### EXAMPLES

These examples are for illustrative purposes only and are not meant to be limiting on the scope of the appended claims. All parts, percentages, ratios, etc. in the examples and the rest of the specification are by weight, unless otherwise noted.

### Coating Materials

| | |
|---|---|
| Epoxy 280 | Scotchcast ™ Electrical Resin 280, available from 3M Company |
| | (St. Paul, MN) |
| Cycloaliphatic epoxy | Hydrophobic liquid modified cycloaliphatic epoxy resin (diglycidylester) |
| | available as Araldite ® CY 5622 from Huntsman Advanced Materials |
| | Americas (The Woodlands, TX) |
| C-7-2 epoxy | Amine curable epoxy resin from ALPS Chemicals Manufacturing Company, |
| | Ltd.(Japan) |
| DDSA | SPI-Chem DDSA (Dodecyl succinic anhydride), CAS # 26544-38-7, |
| | available from Structure Probe, Inc. (West Chester, PA) |
| Accelerator | Tertiary amine based accelerator available as Accelerator DY 062 from |
| | Huntsman Advanced Materials Americas (The Woodlands, TX) |
| ATH1 | Alumina trihydrate available as HYMOD ® M632 alumina trihydrate from J. M. Huber |
| | Corporation (Atlanta, GA) |
| ATH2 | Alumina trihydrate available as H-32I from Showa Denko (Japan) |
| Chromium Catalyst | Cr⁺³ catalyst |

### Core Layer Materials

| | |
|---|---|
| PI1 | 1 mil polyimide film available as 100 HN Kapton ® Film, from Dupont |
| | (Wilmington, DE) |
| PI2 | 2 mil polyimide film available from Tianjin Tianyuan Electronic Material Co., Ltd. |
| | (Japan, Product number is 6052) |
| PEN | 1 mil or 1.5 mil biaxial oriented polyethylene naphthalate film available as |
| | TEONEX ® Q51 from DuPont Teijin Films U.S. Limited Partnership (Chester, VA) |
| NNW | Nylon nonwoven available as Cerex 23030 from CEREX Advanced Fabrics, Inc. |
| | (Cantonment, FL) |
| PPS | 2.2 mil Polyphenylene sulfide nonwoven is a thinner version of nonwoven as |
| | existing Thermal Shield products from 3M Company (St. Paul, MN) |
| Acrylic | Water-Based Acrylic Laminating Adhesives available as ROBOND ™ L-330/CR-9- |
| adhesive | 101 Laminating Adhesive from The Dow Chemical Company (Midland, MI) |

### Test Methods

### Tensile Properties

A 15 mm×200 mm sample was placed in the jaws of a MTS Insight 5 tensile tester available from MTS Systems Corporation (Eden Prairie, Minn.). The jaw gap was 180 mm and the pull rate was 200 mm/min. Tensile strength and elongation at break were measured.

### Comparative Tracking Index (CTI) Test

The comparative Tracking Index (CTI) was measured following IEC-60112 method using a YST-112 Tracking resistance tester available from Yamayoshikenki (Japan). The thickness of the test specimen was 3 mm by stacking individual pieces of the coated films. Solution A as discussed in the method was obtained by dissolving approximately 0.1% by mass of analytical reagent grade anhydrous ammonium chloride (NH4Cl), of a purity of 99.8%, in de-ionized water, having a conductivity of not greater than 1 mS/m to give a resistivity of (3.95±0.05) Ohm-m at room temperature. Two platinum electrodes were placed on the top surface of the stacked film with a 4.0+/−1.0 mm separation distance. 50 drops method was utilized.

### Chemical Resistance

A 15 mm×200 mm test sample was submerged in in Automatic transmission fluid (ATF) at 150° C. for 250 hours. Tensile strength and elongation at break were measured on like samples before and after aging in ATF.

### Coating Formulations

### Epoxy A1

100 parts of cycloaliphatic epoxy (22.1 wt. %), 80 parts dodecyl succinic anhydride (17.7 wt. %); 2 parts of a ternary amine accelerator (0.4 wt. %) and 270 parts of ATH1 (59. wt. %) were combined and mixed in a speed mixer at 2500 rpm for 2 minutes until homogeneous. 5-6% Heptane was added to reduce the viscosity of the epoxy formulation as needed to facilitate coating.

### Epoxy A2

Epoxy A2 was produced by the same process but had a composition of 21.6 wt. % cycloaliphatic epoxy, 19.5 wt. % DDSA, 0.4 wt. % ternary amine accelerator, and 58.5 wt. % ATH1. 5-6% Heptane was added to reduce the viscosity of the epoxy formulation as needed to facilitate coating.

### Epoxy B

100 parts of C-7-2 epoxy resin and 37 parts hardener were combined and mixed in a speed mixer at 2500 rpm for 2 minutes until homogeneous. 5-6 Heptane was added to reduce the viscosity of the epoxy formulation as needed to facilitate coating.

### Epoxy C1

100 parts (40 wt. %) of Epoxy 280 and 150 parts (60 wt. %) ATH1 were combined and mixed in a speed mixer at 2000 rpm for 2 minutes until homogeneous.

10% Heptane was added to reduce the viscosity of the epoxy formulation as needed to facilitate coating.

Epoxy D 39.7 wt. % of Epoxy 280, 0.8 wt. % of a chromium catalyst, and 59.5 wt. % ATH were combined and mixed in a speed mixer at 2500 rpm for 1 minute until homogeneous. 5-6% Methyl ethyl ketone was added to reduce the viscosity of the epoxy formulation as needed to facilitate coating.

### Preparation of Core Layer Materials

Polyphenylene sulfide/polyimide/polyphenylene sulfide laminate (PPS-PI-PPS)

A 1 mil Dupont 100HN Polyimide Film was gravure coated with Robond L-330 water-based acrylic laminating adhesive with CR-9-101 Catalyst on a first side of the PI film. A first 2.2 mil PPS-based nonwoven was laminated onto the PI film between a rubber roll and steel roll at a temperature of about 205° C., a pressure of 17.5 N/mm, and line speed of 13.7 m/min. A second pass through the lamination process was performed on the opposite side resulting in PPS laminated on both sides of the PI base film.

Polyphenylene sulfide/polyethylene naphthalate/polyphenylene sulfide laminate (PPS-PEN-PPS)

A 1 mil PEN Film was Meyer bar coated with Robond L-330 water-based acrylic laminating adhesive with CR-9-101 Catalyst on a first side of the PEN film. A first 2.2 mil PPS-based nonwoven was laminated onto the PEN film between a rubber roll and steel roll at a temperature of about 120° C., a pressure of 5.25 N/mm, and line speed of 1.5 m/min. A second pass through the lamination process was performed on the opposite side resulting in PPS laminated on both sides of the PEN base film.

### Nylon/PEN/Nylon

1 mil Q51 PEN was meyer bar coated with Robond L-330 water-based acrylic laminating adhesive with DOW CR-9-101 Catalyst as the laminating adhesive. The Nylon nonwoven (NNW) was laminated onto the PEN film at a temperature of about 120° C., a pressure of 5.25 N/mm, and line speed of 1.5 m/min. A second pass through the lab-scale lamination process was performed on the opposite side resulting the NNW laminated on both sides of the PEN base film.

### Preparation of Test Samples

The epoxy coatings were coated onto the first side of the core layer materials using a knife coater. The epoxy layer was cured at 150° C. for 15 mins or 20 min. in the case of Example 1. The coating thickness on each side was between 1.0 to 1.5 mils. Samples were cut to an appropriate size as prescribed by the test methods used. The same epoxy coating process was performed on the second side of the core layers resulting in a double-side epoxy coated electrical insulation material.

Table 1 shows the composition of the test specimens and the results of tensile and CTI testing of samples having two cured epoxy layers coated on the exterior surfaces of the core layer and of the comparative examples. Table 2 shows the results of ATF chemical resistance testing.

TABLE 1

| | | | Tensile | Elongation | | | |
|---|---|---|---|---|---|---|---|
| | | Coating | Strength | at Break | CTI at | CTI at | CTI at |
| | Core Layer | Formulation | (N/15 mm) | (%) | 150 V | 350 V | 575 V |
| C1 | PI2 | — | | | | Fail | |
| C2 | PPS-PI1-PPS | — | 140 | 37 | Pass | Fail | |
| C3 | PPS-PEN-PPS | — | 132 | 27 | | Fail | |
| Ex. 1 | PI2 | Epoxy C | | | | Pass | |
| Ex. 2 | PPS-PI-PPS | Epoxy A1 | 177 | 24 | Pass | Pass | Fail |
| Ex. 3 | PPS-PEN-PPS | Epoxy A1 | 169 | 25 | | Pass | Pass |
| Ex. 4 | PPS-PI-PPS | Epoxy B | 177 | 24 | | Pass | |
| | | | | | | (300 V) | |
| Ex. 5 | Nylon-PEN-Nylon | Epoxy A2 | | | | | Pass |

TABLE 2

| | | | | | After aging in ATF | |
|---|---|---|---|---|---|---|
| | | | Before aging | | (250 hours at 150° C.) | |
| | | | Tensile | Elongation | Tensile | |
| | | Coating | Strength | at Break | Strength | Elongation at |
| | Core Layer | Formulation | (N/15 mm) | (%) | (N/15 mm) | Break (%) |
| C3 | PPS-PEN-PPS | — | 132 | 27 | 128 | 16 |
| Ex. 3 | PPS-PEN-PPS | Epoxy A1 | 169 | 25 | 179 | 25 |

In another experiment, Epoxy C mixture was coated onto one side of 2 mil polyimide film from Tianjin Tianyuan Electronic Material Co., Ltd. (Japan, Product number is 6052) using a comma coater, and cured in the oven at 120° C. for 2-3 hours. CTI was tested on the coated side of the prepared samples. A range of epoxy coating thicknesses were applied and tested to show improvement of CTI performance at 350V as a function of thickness of the exterior coating. CTI results can be seen in Table 3. Also included is the values from Example 1 from above.

TABLE 3

| | Thickness | CTI @ 350 V | Number of Drops |
|---|---|---|---|
| Ex. 6a | 0.6 mil | Fail | 37 |
| Ex. 6b | 0.8 mil | Fail | 44 |
| Ex. 6c | 1.2 mil | Fail | 42 |
| Ex. 6d | 1.8 mil | Pass | 50 |
| Ex. 1 | 1.6 mil | Pass | 50 |

Insulating Material with Internal Cured Epoxy Layers (Ex. 7)

A 1 mil Dupont 100HN Polyimide Film core layer was coated with Epoxy D on a lab-scale knife coater. A nylon nonwoven layer was embedded and rolled into the surface of the wet epoxy coating. The epoxy coating layer was then cured at 150° C. for 15 mins. The same epoxy coating and embedding process was performed on the second side of the core layer resulting in an electrical insulation material having nonwoven nylon surface layers adhered to a polyimide core layer by an internal cured epoxy layer. This material passed the CTI test at both 350V and 575V. In contrast, a corresponding uncoated Nylon/PI/Nylon passed CTI at 150V, but failed at 350V (9 drops).

### Effects of Filler in the Epoxy Formulation (Ex. 8-Ex.14)

A series of examples were prepared with epoxy formulations having different ATH filler loadings as described previously. These formulations were coated on both sides of a PPS-PEN-PPS laminate and cured as described previously. The adhesive formulation information and the Comparative index (CTI), Dielectric Breakdown Voltage (DBV), Tensile Strength and Elongation at Break for each coated laminate are provided in Table 4. Comparative example C4 in Table 4 is an uncoated 1 mil PEN film.

TABLE 4

| | | | | | | | Tensile | Elongation |
|---|---|---|---|---|---|---|---|---|
| | Cycloaliphatic | | | | CTI at | DBV | Strength | at Break |
| | epoxy | DDSA | Accelerator | ATH1 | 575 V | (KV) | (N/15 mm) | (%) |
| C3 | 0 | 0 | 0 | 0 | Fail | 8.6 | 132 | 27 |
| C4 | 0 | 0 | 0 | 0 | Fail | 7 | 93 | 45 |
| Ex. 8 | 54.95 | 43.96 | 1.10 | 0 | Fail | 14 | 178 | 45 |
| Ex. 9 | 45.87 | 36.70 | 0.92 | 16.51 | Pass | 13.9 | 169 | 43 |
| Ex. 10 | 39.37 | 31.50 | 0.79 | 28.35 | Pass | 14.1 | 179 | 37 |
| Ex. 11 | 34.48 | 27.59 | 0.69 | 37.24 | Pass | 12.6 | 176 | 45 |
| Ex. 12 | 30.67 | 24.54 | 0.61 | 44.17 | Pass | 12.1 | 176 | 39 |
| Ex. 13 | 25.13 | 20.10 | 0.50 | 54.27 | Pass | 10.3 | 178 | 38 |
| Ex. 14 | 22.12 | 17.70 | 0.44 | 59.73 | Pass | 8.3 | 168 | 41 |

Table 5 shows additional aging results for Ex. 12 and C3. The samples were aged separately in air at 180° C., and aged in Automotive Transmission Fluid (ATF) at 150° C. for 1000 hours.

TABLE 5

| | | Tensile | Elongation | |
|---|---|---|---|---|
| | | Strength | at Break | DBV |
| Aging test | Sample | (N/15 mm) | (%) | (KV) |
| 180° C. in Air (1000 hours) | C3 | 79 | 2 | 9.4 |
| 180° C. in Air (1000 hours) | Ex. 12 | 188 | 28 | 10.0 |
| 150° C. in ATF (1000 hours) | C3 | 118 | 11 | 9.8 |
| 150° C. in ATF (1000 hours) | Ex. 12 | 145 | 25 | 13.6 |

Table 4 illustrates that the epoxy coated laminate (Ex. 12) retains greater than 60% of its original material properties (e.g. elongation at break) after aging in either air or ATF at elevated temperatures even after 1000 hours. Some material properties such as the dielectric break down strength and the tensile strength retained at least 80% of the original material properties (e.g. elongation at break) after aging in either air or ATF at elevated temperatures even after 1000 hours.

Various modifications of the exemplary electrical insulating materials described herein including equivalent processes, as well as numerous structures to which the present invention may be applicable will be readily apparent to those of skill in the art to which the present invention is directed upon review of the present specification.

We claim:

1. A flexible electrical insulating material comprising an insulating core layer and at least one cured epoxy layer coated on a first major surface of the insulating core layer, wherein the insulating core layer is a laminate comprising first layer of a nonwoven material attached to a first surface of an insulating film by a laminating adhesive.

2. The insulating material of claim 1, wherein a first layer of the at least one cured epoxy layer is coated on an exposed surface of the first layer of a nonwoven material.

3. The insulating material of claim 1, wherein a first layer of the at least one cured epoxy layer is coated on an exposed surface of the film.

4. The insulating material of claim 1, wherein the insulating core layer further comprises a second layer of a nonwoven material attached to a second surface of a polymer film.

5. The insulating material of claim 1, wherein the at least one cured epoxy layer is coated on both major surfaces of the core layer.

6. The insulating material of claim 1, wherein the cured epoxy layer comprises a cycloaliphatic epoxy resin, a hardener, and aluminum trihydrate.

7. The insulating material of claim 1, wherein the cured epoxy layer comprises of 15-50 wt. % cycloaliphatic epoxy resin, 10-50 wt. % anhydride hardener, and 10-70 wt. % aluminum trihydrate.

8. The insulating material of claim 1, wherein the nonwoven material comprises one of a polyphenylene sulfide nonwoven material and a nylon nonwoven material, and the insulating film comprises one of a polyimide film and a polyethylene-naphthalate film.

9. The insulating material of claim 1 having a comparative tracking index of at least about 350 V.

10. The insulating material of claim 1, wherein the insulating material has been formed into a three-dimensional shape configured to fit into a slot of a motor coil.

11. A flexible electrical insulating material comprising an insulating film layer, a first cured epoxy layer disposed on a major surface of the insulating film layer and a first nonwoven material layer disposed on an exposed surface of the first cured epoxy layer.

12. The insulating material of claim 11, further comprising a second cured epoxy layer disposed on the second major surface of the insulating film.

13. The insulating material of claim 12, further comprising a second nonwoven material layer disposed on an exposed surface of the second cured epoxy layer

14. The insulating material of claim 11, wherein the cured epoxy layer comprises a cycloaliphatic epoxy resin, a hardener, and aluminum trihydrate.

15. The insulating material of claim 4, wherein the cured epoxy layer comprises of 15-50 wt. % cycloaliphatic epoxy resin, 10-50 wt. % anhydride hardener, and 10-70 wt. % aluminum trihydrate.

16. The insulating material of claim 11, wherein the first nonwoven material comprises one of a polyphenylene sulfide nonwoven material and a nylon nonwoven material, and wherein the insulating film comprises one of a polyimide film and a polyethylene-naphthalate film.

17. The insulating material of claim 11 having a comparative tracking index of at least about 350 V.

18. The insulating material of claim 11, wherein the insulating material has been formed into a three-dimensional shape configured to fit into a slot of a motor coil.

19. The insulating material of claim 13, wherein the three-dimensional shape is a channel having one of a U-shaped cross-section, an elliptical cross-section, a rectangular cross section and a dovetail cross-section.

20. The insulating material of claim 11, wherein the ends of the insulating material are folded back at one or both ends to form a cuff to reinforce the three-dimensional shape.
